(19) United States
(12) Patent Application Publication
(10) Pub. No.: US 2014/0307973 A1
(43) Pub. Date: Oct. 16, 2014

(54) Text Recognition Techniques

(71) Applicant: ADOBE SYSTEMS INCORPORATED, San Jose, CA (US)

(72) Inventor: Barry Young, Aptos, CA (US)

(73) Assignee: Adobe Systems Incorporated, San Jose, CA (US)

(21) Appl. No.: 13/860,180

(22) Filed: Apr. 10, 2013

(51) Int. Cl. G06K 9/80

(52) U.S. Cl. CPC G06K 9/80
USPC 382/200; 382/229; 382/203

(57) ABSTRACT

Text recognition techniques are described. In one or more implementations, image data is received via a network at a service provider. One or more image deblurring or curve correction techniques are applied to the image data, text is recognized from the deblurred image data using one or more optical character recognition techniques, and the recognized text is exposed for access via the network.

### BACKGROUND

Mobile communication devices such as mobile phones and tablets have become a part of everyday life for a large segment of the population. As a result of this, users may employ the mobile communication devices for uses for which the device was not originally designed.

A mobile communication device, for instance, may include an integrated camera that may have a relatively high resolution. Users may then employ this camera for a variety of purposes, such as to capture images of friend, scenery, and even capture images of documents or other text to be read later. However, conventional techniques that were utilized to perform optical character recognition on such images could fail due to corruption that may be captured as part of the image.

### SUMMARY

Text recognition techniques are described. In one or more implementations, image data is received via a network at a service provider. One or more image deblurring techniques are applied to the image data, text is recognized from the deblurred image data using one or more optical character recognition techniques, and the recognized text is exposed for access via the network.

In one or more implementations, image data is received via a network at a service provider and a curvature is detected in the image data. A correction is applied to remove at least part of the detected curvature and text is recognized from the corrected image data using one or more optical character recognition techniques. The recognized text is exposed by the service provider for access via the network.

In one or more implementations, a system includes one or more computing devices configured to implement a service provider that is accessible via a network. The one or more computing devices are configured to perform operations that include processing image data received via a network using one or more image deblurring techniques and one or more curvature techniques to at least partially remove a curvature detected in the image. Text is recognized from the processed image data using one or more optical character recognition techniques and the recognized text is exposed for access via the network.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 depicts a system in an example implementation in which a computing device communicates with a service provider via a network to utilize one or more debluring algorithms as part of optical character recognition.

FIG. 3 depicts a system in an example implementation in which a service provider is configured to utilize one or more curve correction algorithms as part of optical character recognition.

FIG. 4 is a flow diagram depicting a procedure in an example implementation in which deblurring operations are performed as part of optical character recognition.

FIG. 5 is a flow diagram depicting a procedure in an example implementation in which curve correction operations are performed as part of optical character recognition.

FIG. 6 illustrates an example system including various components of an example device that can be implemented as any type of computing device as described and/or utilize with reference to FIGS. 1-5 to implement embodiments of the techniques described herein.

### DETAILED DESCRIPTION

### Overview

The increasing pervasiveness of mobile computing devices has resulted in users treating the integrated cameras of these devices as a scanner, such as to capture an image of a page of a textbook, whiteboard, and so on. However, while these images may be sufficient for viewing by a user, conventional optical character recognition techniques could fail when confronted with these images, which may be caused by artifacts and other corruption.

Techniques are described in which images may be processed to improve suitability for optical character recognition techniques. For example, a service provider may expose one or more services that are accessible via application programming interfaces. These services may be employed such that a mobile communication device or other device may upload an image captured by one or more image sensors. The image may then be processed by the service provider, such as to employ one or more deblur algorithms, curvature correction techniques, and so on. Optical character recognition techniques may then be employed using the processed image to recognize text in the image. For example, a plurality of different techniques may be employed and a result of one or more of them may be selected based on a dictionary look up. The results may then be exposed, such as for communication back to the mobile communication device, made via a user interface, and so on. A variety of other examples are also contemplated as further described in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

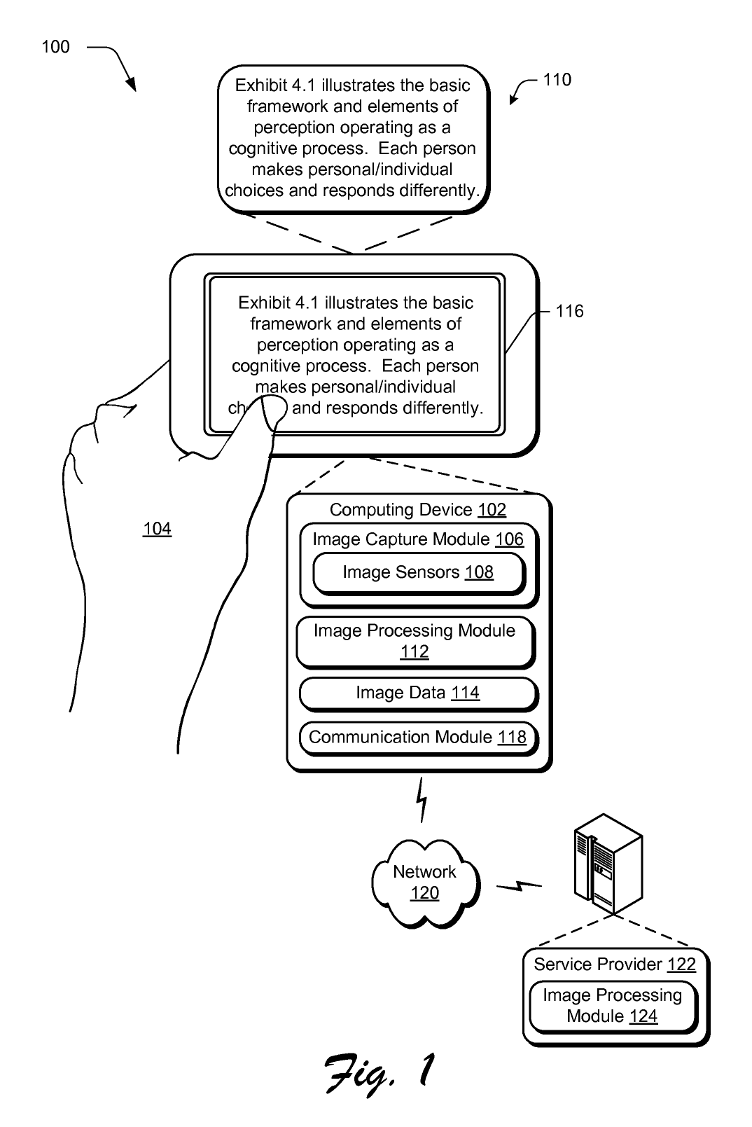

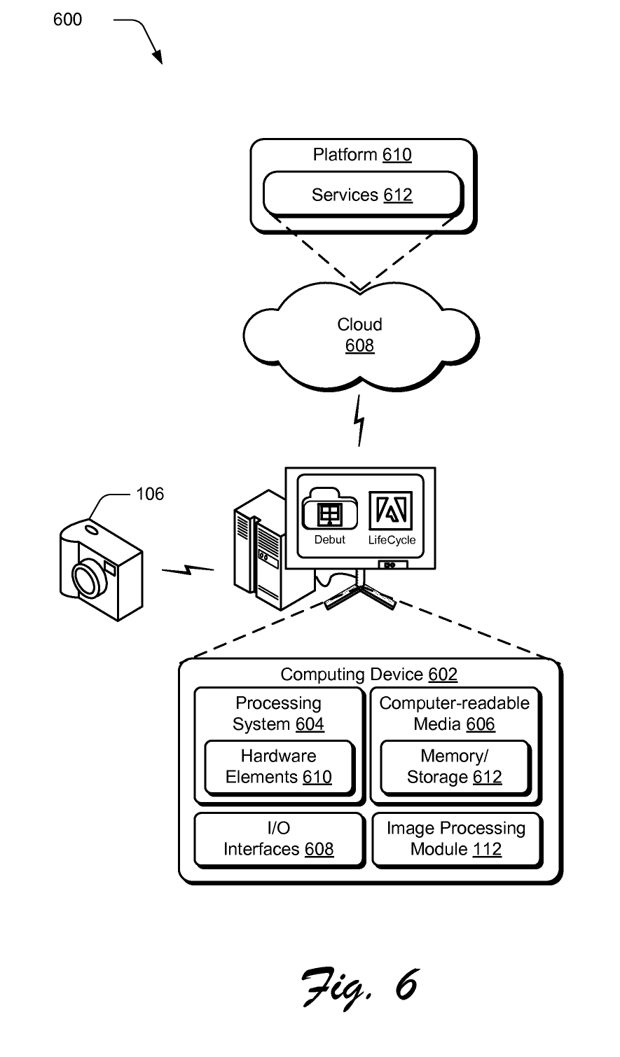

FIG. 1 is an illustration of an environment 100 in an example implementation that is operable to employ techniques described herein. The illustrated environment 100 includes a computing device 102, which may be configured in a variety of ways. The computing device 102, for instance, may be configured as a desktop computer, a laptop computer, a mobile communication device as illustrated as being held in a user's hand 104 (e.g., assuming a handheld configuration such as a tablet or mobile phone), and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices, such as multiple servers utilized by a business to perform operations “over the cloud” as further described in relation to FIG. 6.

The computing device 102 is illustrated as including an image capture module 106 having one or more image sensors 108. Although illustrated as part of the computing device 102, a variety of other examples are also contemplated. For example, the image capture module 106 may be implemented as a video camera, scanner, copier, camera, and so forth.

Regardless of how implemented, the image capture module 106 may be employed to capture an image of an image scene 110 using the one or more image sensors 108. In the illustrated example the image scene 110 includes a document but a variety of other instances are also contemplated in which the image scene 110 includes text or other objects to be identified. This data may then be processed by an image processing module 112 to form image data 114. This processing may involve a variety of different techniques, such as de-mosaicking, Bayer pattern removal, artifact removal, and so on.

The computing device 102 is also illustrated as including a communication module 118. The communication module 118 is representative of functionality of the computing device 102 to communicate via a network 120. This may include use of wired and/or wireless protocols to send and receive communications. Communication may be performed to access a variety of different functionality, which may include communication with a service provider 122 to utilize one or more image processing techniques, implementation of which is illustrated as an image processing module 124.

The image processing module 124, like the image processing module 112 of the computing device 102, is representative of a variety of different image processing techniques. This may include techniques to process image data 114 to increase suitability for use of optical character recognition techniques as well as the optical character recognition techniques themselves. Accordingly, although the example described below describes implementation by the service provider 122 a variety of other examples are also contemplated, such as implementation by the computing device 102, a different third party device, and so on.

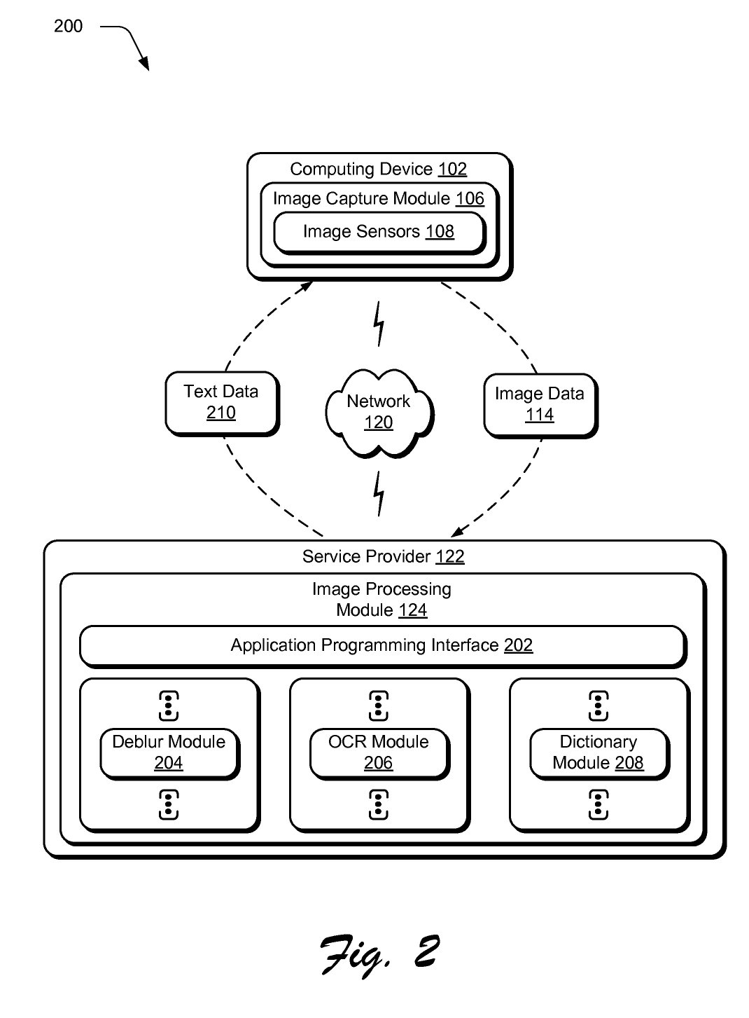

FIG. 2 depicts a system 200 in an example implementation in which a computing device 102 communicates with the service provider 122 via the network 120 to utilize one or more debluring algorithms as part of optical character recognition. As before, the computing device 102 includes an image capture module 106 having one or more image sensors 108 configured to capture image data 114. The image data 114 may be configured in a variety of ways, such as in a raw image format, RGB, and so on.

The image data 114 is communicated over the network 120 to a service provider 122. This may be performed in a variety of ways, such as to “hook into” one or more application programming interfaces 202 of an image processing module 124. The image data 114 may then be processed using functionality of the image processing module 124, illustrated examples of which include one or more deblur modules 204, one or more OCR modules 206, and one or more dictionary modules 208.

The one or more deblur modules 204 are representative of functionality involving one or more deblur algorithms. The deblur algorithms, for instance, may be used for shake removal, motion correction algorithms, and so forth. Shake removal algorithms, for instance, may be used to remove jitter in the image data 114 caused by movement of a user's hand 104 when holding the computing device 102. Motion correction algorithms, on the other hand, may be configured to remove motion caused by movement of object in an image scene 110, such as movement of a document in the image scene 110 caused by air movement and so on. Thus, the deblur modules 204 may be representative of a variety of different deblur techniques that may be used to remove corruption, artifacts, and other errors that may be captured as part of the image data 114.

The OCR modules 206 are likewise representative of functionality involving optical character recognition. This may include functionality to recognize characters including alphabetic, numeric, typographic (e.g., @, #), and other text. Further, each of these OCR modules 206 may employ different algorithms, thresholds, and so on in the performance of this recognition. Thus, an output of each of the OCR modules 206 may be different, one to another.

Accordingly, The image processing module 124 may employ one or more dictionary modules 208 to identify words, phrases, utterances, and so on from the output of the OCR modules 206. This may be used as a basis to select an output of one or more of the OCR modules 206, combine an output, and so on.

Selected text data 210 may then be exposed by the service provider 122. This may include making the text data 210 available via one or more application programming interfaces 202, exposure of the text data 210 in a user interface, formation of a communication to communicate the text data 210 back to the computing device 102, and so on. Thus, in this way the computing device 102 may leverage functionality made available via the service provider 122 to arrive at text data 210 from image data 114 captured by the computing device 102.

A variety of other examples are also contemplated, such as to process image data 114 captured from a different computing device (e.g., to capture from phone and provide to desktop or other service provider 122 such as an image management service), further divide which of the entities perform the operations (e.g., to perform deblurring at the service provider 122 and OCR at the computing device 102 or vice versa, use of different service providers), and so on. A variety of other techniques may also be utilized to improve readiness of the image data 114 for processing by the OCR modules 206, an example of which is described as follows and shown in a corresponding figure.

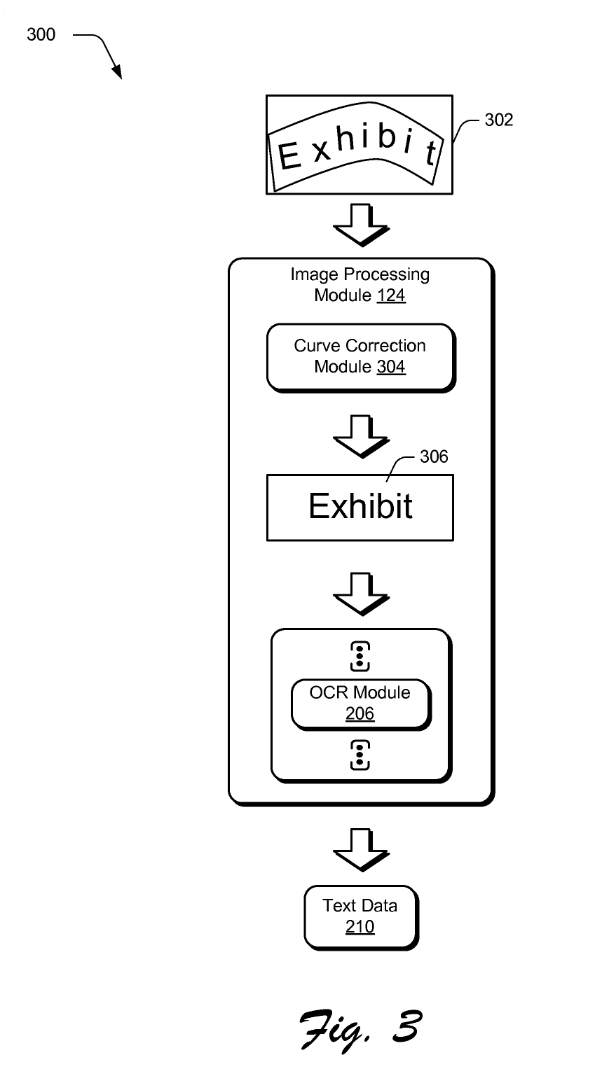

FIG. 3 depicts a system 300 in an example implementation in which the service provider 122 is configured to utilize one or more curve correction algorithms as part of optical character recognition. In this example, image data 302 is taken of a page of a document that includes text. However, the page in this example is not laid flat such that text included in the image data 302 is curved.

Accordingly, the image processing module 124 may include a curve correction module 304. The curve correction module 304 is representative of functionality to detect a curve exhibited in the image data 302. This may be performed using a variety of different techniques. For example, the curve correction module 304 may detect the skewing of the text in the image and make a correction to arrive at corrected image data 306, such as based on edges of text and other objects in the image data 302. In another example, edges of the document itself in the image data 302 may be used to detect the curvature, such as the medium (e.g., paper) on which text in the image data 302 is disposed. A variety of other examples are also contemplated of detecting curvature that may affect an arrangement of text captured in image data 302.

The corrected image data 306 may then be processed as previously described. For example, this may include processing by one or more of the OCR modules 306 to recognize text. This may also include use of the deblurring techniques as previously described in relation to FIG. 2. The text data 210 may then be exposed for access via the network 120 as previously described. Thus, a variety of different techniques may be utilized to improve readiness of image data for optical character recognition. Further discussion of these and other techniques may be found in relation to the following procedures.

### Example Procedures

The following discussion describes text recognition techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-3.

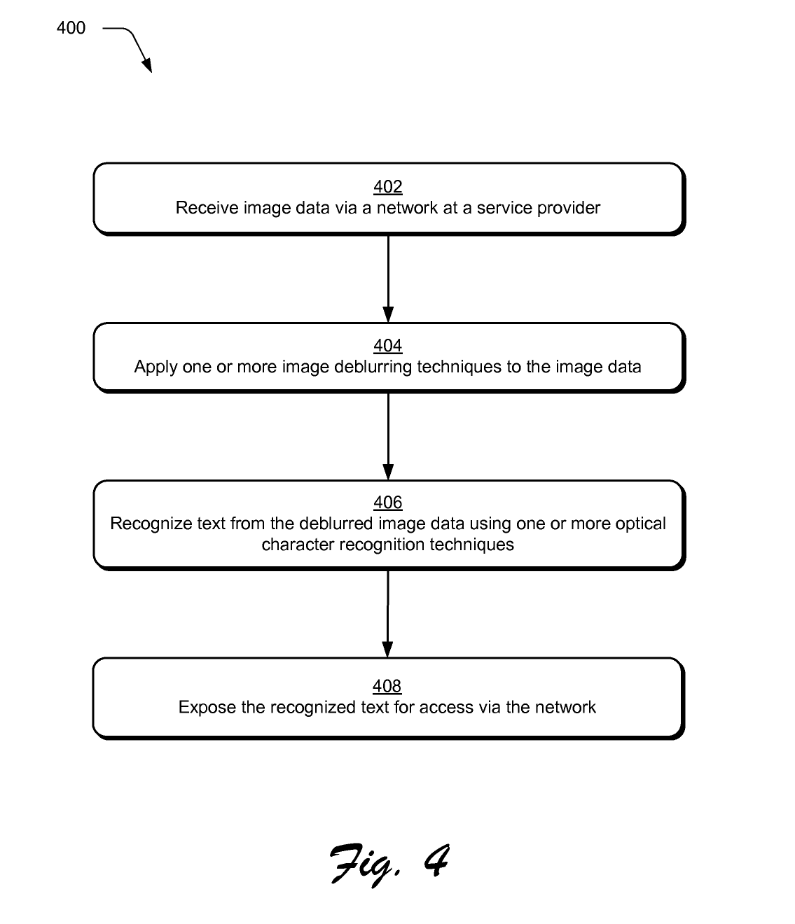

FIG. 4 depicts a procedure 400 in an example implementation in which deblurring operations are performed as part of optical character recognition. Image data is received via a network at a service provider (block 402). The image data 114 may be received in a variety of ways, such as via hooking into one or more APIs 202, via an upload, received via an email, and so on.

One or more image deblurring techniques are applied to the image data (block 404). The image deblurring techniques, for instance, may include shake reduction algorithms and/or motion correction algorithms that are usable to remove an effect of motion of the image capture device and/or object in an image scene.

Text is recognized from the deblurred image data using one or more optical character recognition techniques (block 406). As before, a plurality of different techniques may be employed to arrive at a variety of different results. A selection may then be made based at least in part on a comparison with one or more dictionaries.

The recognized text is exposed for access via the network (block 408). The text may be exposed in a variety of different ways, such as a web interface, via one or more application programming interfaces, via a network address via which the text data is available for download, and so forth.

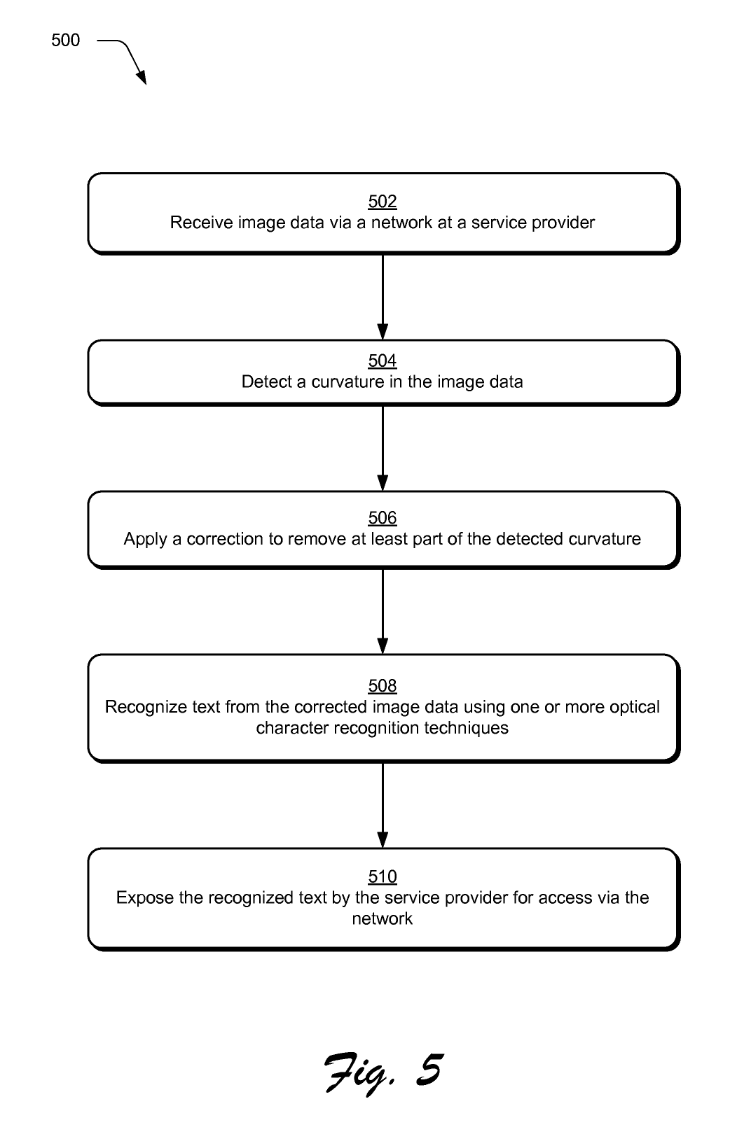

FIG. 5 depicts a procedure 500 in an example implementation in which curve correction operations are performed as part of optical character recognition. Image data is received via a network at a service provider (block 502). As before, the image data may be received in a variety of ways.

A curvature is detected in the image data (block 504). The curvature, for instance, may be detected based on objects on a medium (e.g., text or other objects on paper, a sign, and so on), on the medium itself (e.g., borders of a piece of paper), and so forth.

A correction is applied to remove at least part of the detected curvature and text is recognized from the corrected image data using one or more optical character recognition techniques (block 506). The correction, for instance, may be applied such that the text included in the image data has an improved likelihood of being recognizable.

The recognized text is exposed by the service provider for access via the network (block 508), which may be performed via a communication, output in a web accessible user interface, formed as part of a communication to be communicated via the network 120, and so forth. Thus, a variety of different techniques may be employed to increase readiness of image data for OCR as described above.

### Example System and Device

FIG. 6 illustrates an example system generally at 600 that includes an example computing device 602 that is representative of one or more computing systems and/or devices that may implement the various techniques described herein as illustrated by inclusion of image processing module 112. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 620 via a platform 622 as described below.

The cloud 620 includes and/or is representative of a platform 622 for resources 624. The platform 622 abstracts underlying functionality of hardware (e.g., servers) and software resources of the cloud 620. The resources 624 may include applications and/or data that can be utilized while computer processing is executed on servers that are remote from the computing device 602. Resources 624 can also include services provided over the Internet and/or through a subscriber network, such as a cellular or Wi-Fi network.

The platform 622 may abstract resources and functions to connect the computing device 602 with other computing devices. The platform 622 may also serve to abstract scaling of resources to provide a corresponding level of scale to encountered demand for the resources 624 that are implemented via the platform 622. Accordingly, in an interconnected device embodiment, implementation of functionality described herein may be distributed throughout the system 600. For example, the functionality may be implemented in part on the computing device 602 as well as via the platform 622 that abstracts the functionality of the cloud 620.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving image data via a network at a service provider;
applying one or more image deblurring techniques to the image data;
recognizing text from the deblurred image data using one or more optical character recognition techniques; and
exposing the recognized text for access via the network.

2. A method as described in claim 1, wherein at least one of the one or more image deblurring techniques employs a shake removal algorithm.

3. A method as described in claim 1, wherein at least one of the one or more image deblurring techniques employs a motion correction algorithm.

4. A method as described in claim 1, wherein the image data is received via one or more application programming interfaces (APIs) that are accessible via the network.

5. A method as described in claim 1, wherein the image is captured by a mobile communication device.

6. A method as described in claim 1, wherein the recognizing of the text includes use of a plurality of different optical character recognition techniques and use of one or more dictionaries to select a result from the different optical character recognition techniques.

7. A method as described in claim 1, further comprising
detecting a curvature in the image data; and
applying a correction to remove at least part of the detected curvature, wherein the recognizing is performed using the deblurred image data having the applied correction.

8. A method as described in claim 7, wherein the curvature is detected based on an edge included in the image data.

9. A method as described in claim 7, wherein the curvature is detected based on an arrangement of the text in the image data.

10. A method comprising:
receiving image data via a network at a service provider;
detecting a curvature in the image data;
applying a correction to remove at least part of the detected curvature;
recognizing text from the corrected image data using one or more optical character recognition techniques; and
exposing the recognized text by the service provider for access via the network.

11. A method as described in claim 10, wherein the curvature is detected based on an edge included in the image data.

12. A method as described in claim 11, wherein the edge is image data of a border of a medium that includes the text.

13. A method as described in claim 10, wherein the curvature is detected based on an arrangement of the text in the image data.

14. A method as described in claim 10, further comprising applying one or more image deblurring techniques to the image data and wherein the recognizing is performed using the deblurred image data having the correction applied.

15. A system comprising one or more computing devices configured to implement a service provider that is accessible via a network, the one or more computing devices configured to perform operations comprising:
processing image data received via a network using one or more image deblurring techniques and one or more curvature techniques to at least partially remove a curvature detected in the image;
recognizing text from the processed image data using one or more optical character recognition techniques; and
exposing the recognized text for access via the network.

16. A system as described in claim 15, wherein at least one of the one or more image deblurring techniques employs a shake removal algorithm.

17. A system as described in claim 15, wherein at least one of the one or more image deblurring techniques employs a motion correction algorithm.

18. A system as described in claim 15, wherein the image data is received via one or more application programming interfaces (APIs) that are accessible via the network.

19. A system as described in claim 15, wherein the curvature is detected based on an edge included in the image data.

20. A system as described in claim 15, wherein the curvature is detected based on an arrangement of the text in the image data.
